(19) United States
(12) Patent Application Publication
(10) Pub. No.: US 2014/0047837 A1
(43) Pub. Date: Feb. 20, 2014

(54) METHOD OF IMPROVING NITRITE SALT COMPOSITIONS FOR USE AS HEAT TRANSFER MEDIUM OR HEAT STORAGE MEDIUM

(71) Applicant: BASF SE, Ludwigshafen (DE)

(72) Inventors: Jürgen Wortmann, Limburgerhof (DE); Michael Lutz, Speyer (DE); Johan Ter Maat, Mannheim (DE); Kerstin Schierle-arndt, Zwingenberg (DE); Stephan Maurer, Neustadt-Gimmeldingen (DE); Michael Ladenberger, Darstein (DE); Florian Garlichs, Neustadt (DE); Katharina Kaleta, Heidelberg (DE)

(73) Assignee: BASF SE, Ludwigshafen (DE)

(21) Appl. No.: 13/968,574

(22) Filed: Aug. 16, 2013

Related U.S. Application Data
(60) Provisional application No. 61/684,162, filed on Aug. 17, 2012.

(51) Int. Cl. C09K 5/12

(52) U.S. Cl. CPC C09K 5/12
USPC 60/641.8; 252/71; 422/198; 165/104.11; 126/634

(57) ABSTRACT

Method of maintaining or widening the long-term operating temperature range of a heat transfer medium and/or heat storage medium comprising a nitrite salt composition comprising, as significant constituents, an alkali metal nitrate or an alkaline earth metal nitrate or a mixture of alkali metal nitrate and alkaline earth metal nitrate and in each case an alkali metal nitrite and/or alkaline earth metal nitrite, wherein all or part of the nitrite salt composition is brought into contact with an additive composed of nitrogen and/or noble gases, in each case with elemental oxygen, the latter in an amount in the range from 0 to 20% by volume based on the total amount of the additive in combination with nitrogen oxides and/or compounds which generate nitrogen oxide.

The present invention relates to a method of maintaining or widening the long-term operating temperature range of a heat transfer medium and/or heat storage medium as defined in the claims, a corresponding process system as defined in the claims, the use of an additive for maintaining or widening the long-term operating temperature range of a heat transfer medium and/or heat storage medium as defined in the claims and also a method of generating electric energy in a solar thermal power station as defined in the claims.

Heat transfer media or heat storage media based on inorganic solids, in particular salts, are known both in chemical technology and in power station technology. They are generally used at high temperatures, for example above 100° C., thus above the boiling point of water at atmospheric pressure.

For example, salt bath reactors are used at temperatures of from about 200 to 500° C. in chemical plants for the industrial production of various chemicals.

Heat transfer media are media which are heated by an energy source, for example the sun in solar thermal power stations, and transport the heat comprised therein over a particular distance. They can then transfer this heat to another medium, for example water or a gas, preferably via heat exchangers, with this other medium then being able, for example, to drive a turbine. Heat transfer media can also be used in chemical process technology to heat or cool reactors (for example salt bath reactors) to the desired temperature.

However, heat transfer media can also transfer the heat comprised therein to another medium (for example a salt melt) present in a reservoir and thus pass on the heat for storage. However, heat transfer media can themselves also be introduced into a reservoir and remain there. They are then themselves both heat transfer media and heat storage media.

Heat stores comprise heat storage media, usually materials compositions, for example the mixtures according to the invention, which can store heat for a particular time. Heat stores for fluid, preferably liquid, heat storage media are usually formed by a solid vessel which is preferably insulated against loss of heat.

A still relatively recent field of application for heat transfer media or heat storage media are solar thermal power stations for generating electric energy.

An example of a solar thermal power station is shown schematically in FIG. 1.

In FIG. 1, the numerals have the following meanings:

1 Incoming solar radiation

2 Receiver

3 Stream of a heated heat transfer medium

4 Stream of a cold heat transfer medium

5a Hot part of a heat storage system

5b Cold part of a heat storage system

6 Stream of a hot heat transfer medium from the heat storage system

7 Stream of a cooled heat transfer medium into the heat storage system

8 Heat exchanger (heat transfer medium/steam)

9 Steam stream

10 Condensate stream

11 Turbine with generator and cooling system

12 Current of electric energy

13 Waste heat

In a solar thermal power station, focused solar radiation (1) heats a heat transfer medium, usually in a receiver system (2) which usually comprises a combination of tubular “receivers”. The heat transfer medium generally flows, usually driven by pumps, firstly into a heat storage system (5a), flows from there via line (6) on to a heat exchanger (8) where it gives off its heat to water and thus generates steam (9) which drives a turbine (11) which finally, as in a conventional electric power station, drives a generator for generating electric energy. In the generation of electric energy (12), the steam loses heat (13) and then generally flows back as condensate (10) into the heat exchanger (8). The cooled heat transfer medium generally flows from the heat exchanger (8) back via the cold region (5b) of a heat storage system to the receiver system (2) in which it is reheated by solar radiation and a circuit is formed.

The storage system can comprise a hot tank (5a) and a cold tank (5b), for example as two separate vessels.

An alternative construction of a suitable storage system is, for example, a layer store having a hot region (5a) and a cold region (5b), for example in a vessel.

Further details regarding solar thermal power stations are described, for example, in Bild der Wissenschaft, 3, 2009, pages 82 to 99, and also below.

Three types of solar thermal power stations are particularly important at present: the parabolic trough power station, the Fresnel power station and the tower power station.

In the parabolic trough power station, the solar radiation is focused via parabolic mirror troughs on the focal line of the mirrors. There, there is a tube (usually referred to as “receiver”) filled with a heat transfer medium. The heat transfer medium is heated by the solar radiation and flows to the heat exchanger where, as described above, it transfers its heat for steam generation. The parabolic trough-tube system can reach a length of over 100 kilometers in present-day solar thermal power stations.

In the Fresnel power station, the solar radiation is focused onto a focal line by generally flat mirrors. At the focal line there is a tube (usually referred to as “receiver”) through which a heat transfer medium flows. In contrast to the parabolic trough power station, the mirror and the tube are not moved together to follow the position of the sun, but instead the setting of the mirrors is offered relative to the fixed tube. The setting of the mirrors follows the position of the sun so that the fixed tube is always located on the focal line of the mirrors. In Fresnel power stations, too, molten salt can be used as heat transfer medium. Salt Fresnel power stations are at present largely still in development. Steam generation or the generation of electric energy in the salt Fresnel power station occurs in a manner analogous to the parabolic trough power station.

In the case of the solar thermal tower power station (hereinafter also referred to as tower power station), a tower is encircled by mirrors, in the technical field also referred to as “heliostats”, which radiate the solar radiation in a focused manner onto a central receiver in the upper part of the tower. In the receiver, which is usually made up of bundles of tubes, a heat transfer medium is heated and this produces, via heat exchangers, steam for generating electric energy in a manner analogous to the parabolic trough power station or Fresnel power station.

Heat transfer media or heat storage media based on inorganic salts have been known for a long time. They are usually used at high temperatures at which water is gaseous, i.e. usually at 100° C. and more.

Known heat transfer media or heat storage media which can be used at relatively high temperatures are compositions comprising alkali metal nitrates and/or alkaline earth metal nitrates, optionally in admixture with alkali metal nitrites and/or alkaline earth metal nitrites.

Examples are the products of Coastal Chemical Company LLC Hitec® Solar Salt (potassium nitrate: sodium nitrate 40% by weight: 60% by weight), Hitec® (eutectic mixture of potassium nitrate, sodium nitrate and sodium nitrite).

The nitrate salt mixtures or the mixtures of nitrate and nitrite salts can be used at relatively high long-term operating temperatures without decomposing.

In principle, such mixtures which have a relatively low melting point can be produced by the combination of nitrate salts, usually those of the alkali metals lithium, sodium, potassium with nitrite salts, usually those of the alkali metals lithium, sodium, potassium or of the alkaline earth metal calcium.

In the following, the term alkali metal refers to lithium, sodium, potassium, rubidium, cesium, preferably lithium, sodium, potassium, particularly preferably sodium, potassium, unless expressly indicated otherwise.

In the following, the term alkaline earth metal refers to beryllium, magnesium, calcium, strontium, barium, preferably calcium, strontium, barium, particularly preferably calcium and barium, unless expressly indicated otherwise.

It is still an objective to develop a heat transfer medium or heat storage medium which becomes solid (solidifies) at a relatively low temperature, thus has a low melting point, but has a high maximum long-term operating temperature (analogous to a high decomposition temperature).

For the present purposes, the maximum long-term operating temperature is the highest operating temperature for the heat transfer medium or heat storage medium at which the properties of the medium, for example viscosity, melting point, corrosion behavior, do not change significantly compared to the initial value over a long period of time, in general from 10 to 30 years.

Preference is given to using mixtures of sodium nitrate or potassium nitrate at relatively high temperatures. A routine long-term operating temperature range is from 290 to 565° C. Such mixtures have a relatively high melting point.

However, it is also desirable, in particular for use in power stations for generating heat and/or electric energy, such as solar thermal power stations, chemical process technology plants or metal hardening plants, to lower the melting point of the heat transfer medium in order to reduce the thermotechnical operating outlay, for example.

Mixtures of alkali metal nitrate and/or alkaline earth metal nitrate and alkali metal nitrite and/or alkaline earth metal nitrite usually have a lower melting point than the abovementioned nitrate mixtures, but also a lower decomposition temperature. Such mixtures are usually employed in the temperature range from 150° C. to 450° C. and generally have a relatively high proportion of alkali metal or alkaline earth metal nitrites, for example 30 to 40% by weight.

However, it is desirable, in particular for use in power stations for generating electric energy, e.g. solar thermal power stations, to increase the temperature of the heat transfer medium to far above 400° C., for example to far above 500° C., on arrival in the heat exchanger of the steam generator (known as steam inlet temperature) since the efficiency of the steam turbine is then increased.

It is thus desirable to increase the thermal stability of heat transfer media in long-term operation to, for example, more than about 550° C. and at the same time to keep the melting point thereof relatively low.

The chemical and physical properties of nitrate/nitrite salt mixtures and thus, for example, their long-term operating temperature range in solar thermal power stations can change in an adverse manner in a number of ways.

For example, due to a fault in the plant's operation, for example ingress of oxidative substances, nitrite salts can be oxidized to form nitrate salts, which is not desirable since the melting point of the mixtures is then increased.

For example, when the abovementioned mixtures are subjected, in particular over a prolonged period of time, to comparatively high temperatures, for example above 450° C., they generally decompose into various degradation products.

This generally results in a decrease in the maximum long-term operating temperatures to below an economically and/or technically acceptable value and/or an increase in the melting point to above an economically and/or technically acceptable value. Furthermore, the decomposition of the mixtures mentioned usually also results in an increase in their corrosiveness.

Furthermore, the chemical and physical properties of nitrate/nitrite salt mixtures and thus, for example, their long-term operating temperature range in solar thermal power stations can change in an adverse manner as a result of uptake of traces or even relatively large amounts of water or carbon dioxide, for example due to a leak in the heat transfer medium/steam heat exchanger or as a result of open operation in which the heat transfer media or heat storage media are in contact with the atmospheric moisture of the outside air.

The properties of the nitrate/nitrite salt mixtures can in this way deteriorate to such an extent that they become unsuitable as heat transfer medium or heat storage medium and generally have to be replaced by fresh mixtures, which in the case of the huge amounts comprised in, for example, the piping and storage system of a solar thermal power station having multihour thermal stores is technically and economically disadvantageous or virtually impossible.

It was an object of the present invention to discover a method which avoids or reverses the deterioration of a heat transfer medium or heat storage mediums based on a nitrite salt mixture or widens the long-term operating temperature range of such mixtures.

A further object of the present invention was to discover a method which makes a nitrite salt-comprising heat transfer medium or heat storage medium suitable for higher long-term operating temperatures.

We have accordingly found the methods, process system, use defined in the claims.

For rationality reasons, the nitrite salt compositions defined in the description and in the claims, in particular their preferred and particularly preferred embodiments, will hereinafter also be referred to as “nitrite salt composition of the invention/according to the invention”.

The nitrite salt composition of the invention comprises, as significant constituents, an alkali metal nitrate or an alkaline earth metal nitrate or a mixture of alkali metal nitrate and alkaline earth metal nitrate and in each case an alkali metal nitrite and/or alkaline earth metal nitrite.

The alkali metal nitrate here is a nitrate of the metals lithium, sodium, potassium, rubidium or cesium, preferably lithium, sodium, potassium, particularly preferably sodium, potassium, generally described as MetNO₃, where Met represents the above-described alkali metals, which is preferably virtually water-free, particularly preferably free of water of crystallization, where the term alkali metal nitrate encompasses both a single nitrate and mixtures of the nitrates of these metals, for example potassium nitrate plus sodium nitrate.

The alkaline earth metal nitrate here is a nitrate of the metals magnesium, calcium, strontium, barium, preferably calcium, strontium, barium, particularly preferably calcium and barium, generally described as Met(NO₃)₂, where Met represents the above-described alkaline earth metals, which is preferably virtually water-free, particularly preferably free of water of crystallization, where the term alkaline earth metal nitrate encompasses both a single nitrate and mixtures of the nitrates of these metals, for example calcium nitrate plus magnesium nitrate.

The alkali metal nitrite here is a nitrite of the alkali metals lithium, sodium, potassium, rubidium and cesium, preferably lithium, sodium, potassium, particularly preferably sodium, potassium, generally described as MetNO₂, where Met represents the above-described alkali metals, which is preferably virtually water-free, particularly preferably free of water of crystallization. The alkali metal nitrite can be present as a single compound or as a mixture of various alkali metal nitrites, for example sodium nitrite plus potassium nitrite.

The alkaline earth metal nitrite here is a nitrite of the metals magnesium, calcium, strontium, barium, preferably calcium, strontium, barium, particularly preferably calcium and barium, generally described as Met(NO₂)₂, where Met represents the above-described alkaline earth metals, which is preferably virtually water-free, particularly preferably free of water of crystallization, where the term alkaline earth metal nitrite encompasses both a single nitrite and mixtures of the nitrites of these metals, for example calcium nitrite plus magnesium nitrite.

Preference is given to the following nitrite salt compositions according to the invention:

nitrite salt composition according to the invention comprising, as significant constituents, an alkali metal nitrate and/or alkaline earth metal nitrate and in each case an alkali metal nitrite and/or alkaline earth metal nitrite;

nitrite salt composition according to the invention comprising, as significant constituents, an alkali metal nitrate selected from among sodium nitrate and potassium nitrate and in each case an alkali metal nitrite and/or alkaline earth metal nitrite;

nitrite salt composition according to the invention comprising, as significant constituents, an alkali metal nitrate and an alkali metal nitrite;

nitrite salt composition according to the invention comprising, as significant constituents, an alkali metal nitrate and an alkali metal nitrite selected from among sodium nitrite and potassium nitrite;

nitrite salt composition according to the invention comprising, as significant constituents, an alkali metal nitrate selected from among sodium nitrate and potassium nitrate and in each case an alkali metal nitrite selected from among sodium nitrite and potassium nitrite and/or an alkaline earth metal nitrite selected from among calcium nitrite and barium nitrite;

nitrite salt composition according to the invention comprising, as significant constituents, an alkali metal nitrate and/or alkaline earth metal nitrate and an alkali metal nitrite selected from among sodium nitrite and potassium nitrite;

Further very useful nitrite salt compositions according to the invention comprising, as significant constituents, an alkali metal nitrate and an alkali metal nitrite are, for example, the following:

Alkali metal nitrate, preferably sodium nitrate and/or potassium nitrate, in an amount in the range from 5 to 95% by weight, preferably from 20 to 80% by weight, particularly preferably from 50 to 70% by weight, and alkali metal nitrite, preferably sodium nitrite and/or potassium nitrite, in an amount in the range from 95 to 5% by weight, preferably from 80 to 20% by weight, particularly preferably from 50 to 30% by weight, in each case based on the mixture.

Further very useful nitrite salt compositions according to the invention comprise not only alkali metal nitrates and/or alkali metal nitrites but also alkaline earth metal nitrates and/or alkaline earth metal nitrites as follows:

(i) The nitrate salt content here is in a range from 5 to 98% by weight, preferably from 50 to 95% by weight, particularly preferably from 70 to 90% by weight, and the nitrite salt content is in a range from 2 to 95% by weight, preferably from 5 to 50% by weight, particularly preferably from 10 to 30% by weight, in each case based on the mixture.

(ii) The alkali metal salt content here is in a range from 5 to 99% by weight, preferably from 30 to 90% by weight, particularly preferably from 50 to 80% by weight, and the alkaline earth metal salt content is in a range from 1 to 95% by weight, preferably from 10 to 70% by weight, particularly preferably from 20 to 50% by weight, in each case based on the mixture.

Preferred alkali metals in the above mixtures (i) and (ii) are sodium and potassium. Preferred alkaline earth metals in the above mixtures (i) and (ii) are calcium and barium.

A mixture of potassium nitrate, sodium nitrate and sodium nitrite is commercially available, for example as the product Hitec® from Coastal Chemical Company LLC.

Apart from the abovementioned significant components, the nitrite salt composition of the invention can comprise traces of further constituents, for example oxides, chlorides, sulfates, carbonates, hydroxides, silicates of the alkali metals and/or alkaline earth metals, silicon dioxide, iron oxide, aluminum oxide or water. The sum of these constituents is generally not more than 1% by weight, based on the nitrite salt composition of the invention.

The sum of all constituents of the nitrite salt composition of the invention is in each case 100% by weight.

The nitrite salt composition of the invention goes over into the molten and usually pumpable form at a temperature above about 100-220° C., depending, inter alia, on the nitrite content and the ratio of the cations forming the mixture.

The nitrite salt composition of the invention generally has such a concentration of nitrites that the melting point of the nitrite salt composition of the invention is in the range from 100 to 220° C., preferably in the range from 100 to 180° C., hereinafter referred to as “correct nitrite operating concentration”.

If the concentration goes below the correct nitrite operating concentration, this generally leads to an increase in the melting point of the nitrite salt composition and thus incurs the risk of the plant going down; such plants are, for example, power stations for generating heat and/or electric energy, plants in chemical process technology, for example salt bath reactors and metal hardening plants.

The nitrite salt composition of the invention, preferably in molten form, for example as pumpable liquid, is used as heat transfer medium and/or heat storage medium, preferably in power stations for generating heat and/or electric energy, in chemical process technology, for example in salt bath reactors, and in metal hardening plants.

Examples of power stations for generating heat and/or electric energy are solar thermal power stations such as parabolic trough power stations, Fresnel power stations, tower power stations.

For example, the thermal energy generated in power stations, preferably in solar thermal power stations, can be used for thermal water treatment, for example in seawater desalination plants or for generating process heat in industrial applications, for example for ore processing.

In a very useful embodiment, the nitrite salt compositions of the invention, preferably in the molten state, for example as pumpable liquid, are used both as heat transfer medium and as heat storage medium in the solar thermal power stations, for example in parabolic trough power stations, tower power stations or Fresnel power stations.

In a further very useful embodiment, the nitrite salt compositions of the invention, preferably in the molten state, for example as pumpable liquid, are used either as heat transfer medium or as heat storage medium in the solar thermal power stations, for example parabolic trough power stations, tower power stations, Fresnel power stations.

For example, the nitrite salt compositions of the invention, preferably in the molten state, for example as pumpable liquid, are used in tower power stations as heat transfer medium and/or as heat storage medium, particularly preferably as heat transfer medium.

When the nitrite salt compositions of the invention, preferably in the molten state, for example as pumpable liquid, are used as heat transfer medium in solar thermal power stations, for example parabolic trough power stations, tower power stations, Fresnel power stations, the heat transfer media are passed through tubes heated by solar radiation. They usually convey the heat arising there to a heat store or to the heat exchanger of the steam heater of a power station.

The heat store comprises, in one variant, a plurality of, usually two, large vessels, generally a cold vessel and a hot vessel (also referred to as “two-tank store”). The inventive nitrite salt composition, preferably in the molten state, for example as pumpable liquid, is usually taken from the cold vessel of the solar plant and heated in the solar field of a parabolic trough plant or a tower receiver. The hot molten salt mixture which has been heated in this way is usually introduced into the heated vessel and stored there until there is demand for generating electric energy.

Another variant of a heat store of the “thermoclinic store” comprises a tank in which the heat storage medium is stored in layers at different temperatures. This variant is also referred to as “layer store”. When storage is carried out, material is taken from the cold region of the store. The material is heated and fed back into the hot region of the store for storage. The thermoclinic store is thus used in a manner largely analogous to a two-tank store.

The hot nitrite salt compositions of the invention in the molten state, for example as pumpable liquid, is usually taken from the hot tank or the hot region of the layer store and pumped to the steam generator of a steam power station. The steam produced there, which is at a pressure of above 100 bar, generally drives a turbine and a generator feeds electric energy to the electricity grid.

At the heat exchanger (salt/steam), the nitrite salt composition of the invention in the molten state, for example as pumpable liquid, is generally cooled to about 290° C. and usually conveyed back into the cold tank or the cold part of the layer store. When heat is transferred from the tubes heated by solar radiation to the store or to the steam generator, the nitrite salt composition of the invention in the molten form acts as heat transfer medium. Introduced into the heat storage vessel, the same nitrite salt composition of the invention acts as heat storage medium, for example to make it possible for electric energy to be generated according to demand.

However, the nitrite salt composition of the invention, preferably in molten form, is also used as heat transfer medium and/or heat storage medium, preferably heat transfer medium, in chemical process technology, for example for heating reaction apparatuses of chemical production plants, where a very high heat flow generally has to be transferred at very high temperatures with a small range of variation. Examples are salt bath reactors. Examples of the production plants mentioned are acrylic acid plants or plants for producing melamine.

The nitrite salt composition of the invention is brought into contact with an additive (in the following also referred to as “additive according to the invention”) composed of nitrogen and/or noble gases, in each case with elemental oxygen, the latter in an amount in the range from 0 to 20% by volume, preferably in the range from 0.1 to 5% by volume, based on the total amount of the additive, in combination with nitrogen oxides and/or compounds which generate nitrogen oxide. Preferred nitrogen oxides in this case are nitrogen monoxide and/or nitrogen dioxide.

The nitrite salt composition of the invention is here generally present in liquid, pumpable, in general molten, form.

A preferred noble gas is argon.

The elemental oxygen, is preferably present in the additive according to the invention in an amount in the range from 0.1 to 5% by volume, based on the total amount of the additive.

The preferred amount of oxygen is preferably determined by the temperature at the place where the additive is added and the desired nitrate-nitrite ratio in the nitrite salt composition of the invention.

For example, in one embodiment, 0.1 to 1% by volume of oxygen, based on the additive according to the invention, at temperatures in the range from 400 to 565° C., results in very useful nitrite salt compositions of the invention having a molar nitrate:nitrite ratio in the range from 1.3:1 to 1:1.

Which nitrogen oxides are present depends on the boundary conditions such as pressure, temperature, presence or absence of oxygen. Examples of nitrogen oxides are dinitrogen monoxide, nitrogen monoxide, nitrogen dioxide and dinitrogen tetroxide.

Compounds which generate nitrogen oxides are all those which liberate nitrogen oxides, for example dinitrogen monoxide, nitrogen monoxide, nitrogen dioxide, dinitrogen tetroxide, under the conditions at the place where the additive is added. Such compounds are, for example, highly nitrated organic compounds such as dinitrotoluene.

Preferred components of the additives according to the invention are selected from the group consisting of nitrogen, argon and the nitrogen oxides nitrogen monoxide and nitrogen dioxide.

In a very useful embodiment, the contacting of the nitrite salt composition of the invention with the additive according to the invention takes place at a temperature in the range from 150 to 600° C., preferably in the range from 150 to 400° C., particularly preferably in the range from 250 to 400° C.

In a very useful embodiment, the contacting of the nitrite salt composition of the invention with the reactive additive takes place at an absolute pressure in the range from 1 to 30 bar, preferably in the range from 1 to 10 bar.

For example, the pressure at the place where the additive according to the invention is added in large heat storage tanks of a solar thermal power station is a few mbar above atmospheric pressure, and the pressure in the central receiver of a solar thermal power station, for example a tower power station, is usually 30 bar.

The contacting of the additive according to the invention with the nitrite salt composition of the invention is generally effected by introducing the additive according to the invention under or above the surface of the nitrite salt composition of the invention which is usually present in liquid, pumpable, in general molten, form.

The contacting of the nitrite salt composition of the invention with the additive according to the invention usually takes place in such a way that the nitrite salt compositions of the invention are preferably intensively mixed, for example by sparging or by introduction into a turbulent liquid stream.

The contacting of the nitrite salt composition of the invention with the additive according to the invention generally takes place in a suitable apparatus. This can be a vessel and/or a pipe through which the nitrite composition of the invention flows or is at rest therein or a subvolume of a vessel or pipe.

For example, in solar thermal power stations, the additive according to the invention can be introduced into a vessel, for example a tank, which comprises the nitrite salt composition of the invention.

For example, in solar thermal power stations having a heat store comprising two tanks, viz. a relatively hot tank and a colder tank, the additive according to the invention is introduced into the hotter tank or the colder tank, in each case preferably under the surface of the nitrite salt composition according to the invention which is present therein.

In one embodiment, the additive according to the invention comprises oxygen in an amount from 0.1 to 5% by volume.

In the variant of introduction into the colder tank, it is preferred to introduce the nitrite salt composition of the invention and comprising the additive according to the invention into the generally hotter heat transfer medium circuit.

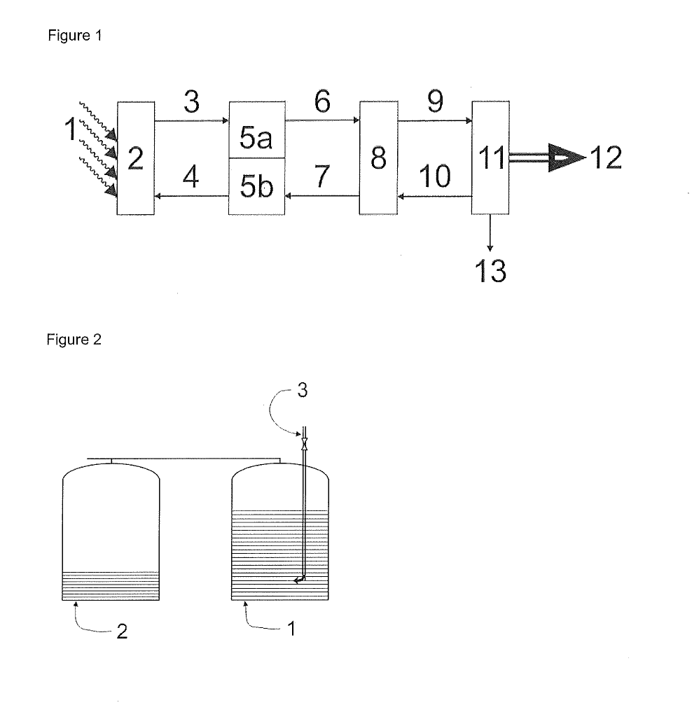

A very useful embodiment of the variant of introduction into the hotter tank is shown by way of example in FIG. 2 and is described below.

In FIG. 2, the numerals have the following meanings.

1 Hot tank

2 Cold tank

3 Introduction of an additive according to the invention

FIG. 2 shows a two-tank storage system into which an additive (3) according to the invention is introduced under the surface of the nitrite salt composition according to the invention in molten form in the hotter tank 1, for example at a temperature greater than about 390° C.

In a heat store which comprises only one tank (also referred to as layer store), a gaseous additive can be introduced only with difficulty under the surface of the heat storage medium. In that case, rising gas bubbles would bring about convection of the heat storage system and the temperature layering of the store would be impaired.

A solution to this problem is to introduce the additive according to the invention onto the surface of the heat storage medium or into a feed stream of the heat transfer medium according to the invention to the store, for example into the hot region of the store.

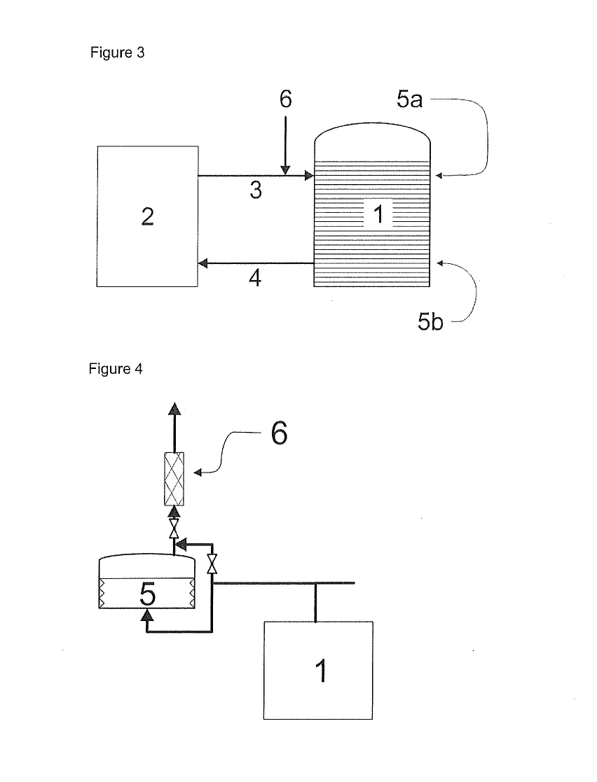

A very useful embodiment of a one-tank heat store (also referred to as layer store) with addition of the additive according to the invention into the feed stream into the hot region of the heat storage system is shown by way of example in FIG. 3 and is described below.

In FIG. 3, the numerals have the following meanings.

1 Layer store

2 Receiver

3 Stream of a heated heat transfer medium according to the invention

4 Stream of a cold heat transfer medium according to the invention

5a Hot region

5b Cold region

6 Introduction of an additive according to the invention

Heated heat transfer medium (3) according to the invention flows from a solar receiver (2) into the hot region (5a) of the store (1). A cold region (5b) is located, for example, beneath the hot region (5a). An additive (6) according to the invention, preferably the additive with oxygen in an amount in the range from 0.1% to 5% by volume, preferably finely dispersed by conventional means, is introduced into the stream (3).

During operation of a heat storage system, operation results in a change in the storage temperature between a maximum value and the minimum value. The materials (heat storage medium and gases above it) and the storage system usually expand to a different degree as a result. These effects can lead to high subatmospheric or superatmospheric pressures in the storage system which are outside the permissible pressure range. These undesirable pressure effects can be controlled by breathing of the store using a suitable gas, for example air and/or nitrogen. If the atmosphere of the vessel of the heat storage system comprises an additive which comprises, for example, nitrogen dioxide (NO₂), nitrogen monoxide (NO) or mixtures thereof, nitrous gases can thus be released into the environment.

A solution to this problem is shown by way of example in FIG. 4 and is described below.

In FIG. 4, the numerals have the following meanings.

1 Heat storage system

5 Gas buffer system

6 Nitrogen oxide separator and/or remover

During operation, the heat storage system (1) requires breathing via the gas space. For this purpose, gases can be released into the environment via a nitrogen oxide separator and/or remover (6), for example a DeNOx catalyst and/or a condenser, in case of superatmospheric pressure. Should subatmospheric pressure occur in the storage system (1), a suitable breathing gas, for example air or nitrogen, can be introduced by conventional means. In addition, a gas buffer system (5) can be used to effect temporary storage (buffering) of the amounts of gas given off from the heat store during heating, in order to introduce them back into the storage system on cooling so as to avoid subatmospheric pressure. As a result of this measure, the amount of gases introduced into the heat storage system, preferably via the nitrogen oxide separator and/or remover (6), for example DeNOx catalyst and/or condenser, is effectively reduced.

An alternative to a gas buffer system is maintenance of the pressure in the storage system by removal or introduction of liquid heat storage medium according to the invention into a separate equalization tank or from a separate equalization tank. The removal and introduction is preferably carried out from or into the cold region of the heat storage system. Excess amounts of gas, e.g. nitrogen and/or nitrogen oxides, in the heat storage system can also arise as a result of decomposition of the heat storage medium. These excess amounts of gas can be conveyed by the heat transfer medium into the relatively cold equalization tank in such a way that the amount of excess nitrogen oxides is reduced. The remaining gas can then be fed to a nitrogen oxide separator and/or remover, for example DeNOx catalyst and/or condenser.

The above-described introductions of the additive according to the invention into heat storage systems generally lead, thanks to the pressure maintenance systems outlined above, to no significant pressure increase in the gas space above the surface of the heat storage medium in the heat storage system. The gauge pressure in the gas space is generally in the range from 0 to 0.01 bar.

In a further embodiment of the invention, the additive according to the invention can be introduced into a vessel which is connected in parallel to the main amount of the nitrite salt composition according to the invention in molten form and into which a partial amount of the nitrite salt composition according to the invention is introduced and taken from, either discontinuously or preferably continuously.

The introduction of the additive according to the invention into a vessel connected in parallel to the main stream of the flowing nitrite salt composition according to the invention has the advantage that, regardless of the respective operating pressure of the main stream, a different, advantageously higher, pressure and/or a different temperature can be selected in the vessel connected in parallel, which usually results in a faster reaction and therefore a higher degree of regeneration of the nitrite salt mixture according to the invention.

For example, it is possible, in this embodiment, to introduce the additive according to the invention as a relatively low temperature, for example from 250 to 350° C., and then convey the thus-treated nitrite salt mixture according to the invention into the generally colder heat transfer medium circuit. Well-suited additives for this process variant are, for example, nitrogen together with oxygen, the latter in an amount in the range from 15 to 20% by volume, based on the total amount of the additive, in combination with nitrogen oxides.

In another example, it is possible in this embodiment to introduce the additive according to the invention at a relatively high temperature, for example from 400 to 550° C., and then convey the thus-treated nitrite salt mixture according to the invention into the generally hotter heat transfer medium circuit. Well-suited additives for this process variant are, for example, nitrogen together with oxygen, the, latter in an amount in the range from 0.1 to 5% by volume, based on the total amount of the additive, in combination with nitrogen oxides.

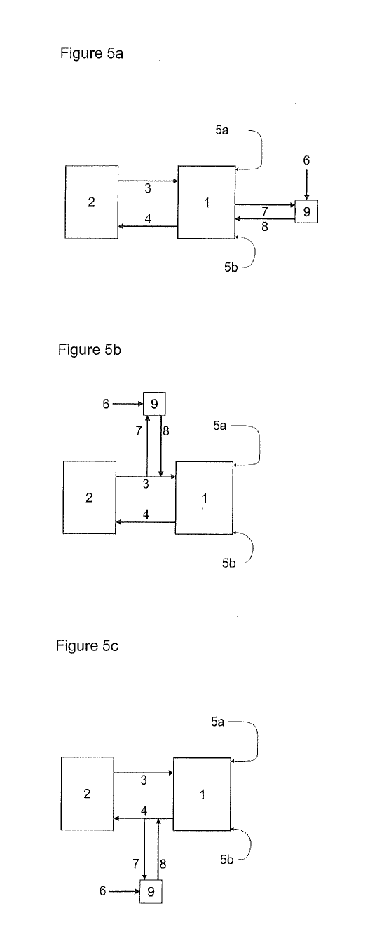

Very useful embodiments of the above-described “parallel vessel embodiment” of the invention are described below by way of example for a solar thermal power station and are shown schematically in FIG. 5.

Here,

FIG. 5a shows the introduction into the heat storage system

FIG. 5b shows the introduction into the stream of the heated heat transfer medium

FIG. 5c shows the introduction into the stream of a cold heat transfer medium.

In FIG. 5, the numerals have the following meanings.

1 Heat storage system

2 Receiver system

3 Stream of a heated heat transfer medium according to the invention

4 Stream of a cold heat transfer medium according to the invention

5a Hot region of the heat storage system

5b Cold region of the heat storage system

6 Introduction of an additive according to the invention

7 Taking off of a substream of the heat transfer medium according to the invention

8 Recirculation of the substream of the heat transfer medium according to the invention

9 External reaction vessel

Three variants showing how contacting of the nitrite salt mixture of the invention with an additive according to the invention can be configured for a solar thermal power station (see FIG. 1) are outlined by way of example in FIG. 5. All the variants have a receiver system (2) which exchanges a heat transfer/storage medium with a heat storage system (1) via the lines (3) and (4). The heat storage system (1) has a hot region (5a) and a cold region (5b). In the one variant (FIG. 5a), the substream is, by way of example, taken from a middle temperature region of the heat storage system. Taking it from a hot or cold region of the storage system is likewise possible. In the second variant (FIG. 5b), the substream is taken from the heated main stream (3) of the heat transfer medium. In the third variant (FIG. 5c), it is taken from the cold main stream (4) of heat transfer medium.

The branching-off of the substream of the nitrite salt composition of the invention is carried out, for example, by pumping. After the substream has been taken off, it is contacted with the additive according to the invention in a separate reaction vessel. The reaction vessel can be set by conventional means to a different, preferably higher pressure and/or an altered temperature compared to the offtake temperature in order to achieve, for example, a higher degree of regeneration of the nitrite salt mixture of the invention.

The amount of the additive according to the invention which is brought into contact with the nitrite salt composition of the invention depends on the technical problem to be solved and can be determined by a person skilled in the art using conventional methods for determining the composition of the nitrite salt composition which is to be brought into contact with the additive according to the invention.

Examples of these methods are analytical methods such as determination of the basicity, of the melting point, determination of the nitrite and/or nitrate content of the nitrite salt composition which is brought into contact with the additive according to the invention.

In a useful embodiment, for example well-suited to solar thermal power stations, the basicity of the nitrite salt composition according to the invention which is to be brought into contact with the additive according to the invention is determined, for example, by acid-based titration or potentiometrically. This determination can be carried out in-line, on-line or off-line. On the basis of the basicity value determined in this way, the amount of the additive according to the invention is determined and introduced, leading to complete neutrality of the nitrite salt composition according to the invention, but preferably to a small residual basicity, as defined below, in the nitrite salt composition according to the invention.

For the present purposes, the basicity (alkalinity) is the specific amount of acid equivalents which an aqueous solution of a salt melt can take up until it reaches pH neutrality. The sensor parameter “alkalinity” can be measured in-line, on-line or off-line. The target value of “alkalinity” should be 0.001-5%, preferably 0.005-1% and particularly preferably 0.01-0.5%. Instead of measuring the alkalinity by means of titration, a substitute sensor parameter can also be employed after appropriate calibration. Substituted parameters can be: density, optical parameters (spectrum), etc.

If the additive according to the invention is used in a substoichiometric amount, offgas treatment, for example using a nitrogen oxide separator and/or remover, for example DeNOx catalyst and/or condenser, may be able to be dispensed with.

In another embodiment, it is possible, for example in the case of high-temperature plants such as solar thermal tower power stations, to deliberately use the additive according to the invention in a superstoichiometric amount.

Unconsumed additive according to the invention can, for example, be disposed of and/or preferably, optionally after workup, for example by metering in nitrogen and/or nitrogen oxides, be recycled back into the reaction system, for example the process system as defined below.

The present patent application also provides a process system as defined below and in the claims.

For the purposes of the present invention, a process system is made up of vessels, for example reservoirs such as tanks, in particular heat storage tanks, and/or apparatuses, for example apparatuses for pumping fluids (for example salt melts), e.g. pumps, which are connected by pipes and effect transport and/or storage of thermal energy by means of heat transfer media or heat storage media, for example the primary circuit for heat transfer media and/or heat storage media in solar thermal power stations.

Examples of such pipes are those which are located on the focal line of the parabolic trough mirrors or Fresnel mirrors in solar thermal power stations and/or which form the receiver tubes or receiver tube bundles in solar thermal tower power stations and/or those which, for example in solar thermal power stations, connect particular apparatuses to one another without having the function of collecting solar radiation.

A further example of a process system as defined in the claims is salt bath reactors of chemical process technology and systems formed by connecting them, which in each case comprise the nitrite salt composition of the invention. All or part of the latter is brought into contact with an additive as defined herein.

The present patent application also provides for the use of an additive as defined in the claims for maintaining or widening the long-term operating temperature range of a heat transfer medium and/or heat storage medium comprising a nitrite salt composition as defined in the claims.

For the present purposes, an additive is that which has been described in more detail above and is also described herein as additive according to the invention, including all preferred embodiments. A nitrite salt composition is, for the present purposes, that which has been described in more detail above and is also referred to herein as nitrite salt composition of the invention/according to the invention, including all preferred embodiments.

The abovementioned use preferably relates to a heat transfer medium and/or heat storage medium in a) power stations for generating heat and/or electricity, particularly preferably solar thermal power stations, in particular those of the parabolic trough power station, Fresnel power station or tower power station type, b) in chemical process technology, particularly preferably salt bath reactors, or c) in metal hardening plants.

The present patent application also provides a method of generating electric energy in a solar thermal power station using a nitrite salt composition, as defined in the claims, as heat transfer medium and/or heat storage medium, where all or part of the nitrite salt composition is brought into contact with an additive as defined in the claims.

For the present purposes, an additive is what has been described in more detail above and is also described herein as additive according to the invention, including all preferred embodiments. A nitrite salt composition is, for the present purposes, that which has been described in more detail above and is also referred to herein as nitrite salt composition of the invention/according to the invention, including all preferred embodiments.

The abovementioned method preferably relates to a heat transfer medium and/or heat storage medium in solar thermal power stations of the parabolic trough power station, Fresnel power station or tower power station type.

The present patent application also provides a process for producing nitrite salt mixtures according to the invention, as defined above, wherein mixtures of alkali metal nitrates and/or alkaline earth metal nitrates are brought into contact with an additive according to the invention as defined above including preferred embodiments thereof in the temperature range from 150 to 600° C.

The alkali metal nitrates and alkaline earth metal nitrates are as defined above, including the preferred embodiments thereof.

The mixtures of alkali metal nitrates and/or alkaline earth metal nitrates are selected so that the molar ratio of the respective cations of the nitrate salt mixture corresponds to that in the nitrite salt mixture according to the invention.

The contacting of the mixtures of alkali metal nitrates and/or alkaline earth metal nitrates with the additive according to the invention is generally carried out in a manner analogous to that described above.

The process of the invention for producing nitrite salt mixtures according to the invention generally leads to the nitrite concentration in nitrite salt-comprising heat transfer and/or heat storage media being increased to the “correct nitrite operating concentration” (as defined herein) and/or an excessively high alkalinity in the nitrite salt-comprising heat transfer and/or heat storage media being avoided.

The present patent application also provides for the use of an additive according to the invention for reducing or eliminating the corrosiveness of a nitrite salt mixture according to the invention.

Here, an additive is what has been described in more detail above and is herein also described as additive according to the invention, including all preferred embodiments.

A nitrite salt composition is here what has been described in more detail above and is herein also described as nitrite salt composition according to the invention, including all preferred embodiments.

The corrosiveness usually relates to iron-comprising materials, preferably materials composed of steel, and usually at temperatures in the range from 290 to 650° C., and the nitrite salt composition according to the invention is usually present in molten, preferably pumpable, form.

The abovementioned materials are usually used in pipes or vessels, for example storage vessels such as tanks, or other apparatuses, for example apparatuses for conveying fluids (for example salt melts), e.g. pumps.

Examples of such pipes are those which are present in solar thermal power stations in the focal line of the parabolic trough mirrors or Fresnel mirrors and/or which form the receiver tubes or bundles of receiver tubes in solar thermal tower power stations and/or those which, for example in solar thermal power stations, connect particular apparatuses with one another without having a solar radiation collection function.

A further example of apparatuses in which the abovementioned materials are used are salt bath reactors of chemical process engineering and their connections which in each case come into contact with the nitrite salt compositions according to the invention.

### EXAMPLES

### Example 1

2.8 kg of a salt mixture composed of 7% by weight of sodium nitrate, 53% by weight of potassium nitrate and 40% by weight of sodium nitrite were heated for 90 days in a stirred apparatus made of stainless steel 1.4541. As a result of corrosion of the stainless steel, chromium dissolved from the surface and was present as chromate in the salt melt. The degree of corrosion could therefore be determined via the chromium content of the melt. At an internal temperature of the salt mixture of 585° C., the chromium content rose by 1140 mg/kg over 25 days. At an internal temperature of 550° C., an increase of 200 mg/kg of chromium was observed over 7 days. At 550° C., 1.04 l of nitrogen monoxide (NO) mixed with 20 l of argon were then introduced into the stirred melt by means of a gas inlet tube over a period of 115 minutes. The gas space over the melt was subsequently flushed free of NO by means of argon. After this treatment, the salt mixture was stirred further at 550° C. The chromium content then remained constant for 13 days until the experiment was stopped.

This experiment was able to show that NO in the nitrite salt composition according to the invention suppresses the corrosions reactions.

### Example 2

500 g of a salt mixture composed of 7% by weight of sodium nitrate, 53% by weight of potassium nitrate and 40% by weight of sodium nitrite were placed together with 8 g of sodium hydroxide in a stirred stainless steel apparatus at 200° C. 15.27 g of nitrogen monoxide (NO) together with 10 l of air were introduced below the surface of the melt over a period of 2 hours. After the end of the experiment, a homogeneous sample of the melt was dissolved in water and analyzed. The analysis gave a hydroxide content below the detection limit (<0.1%), while the nitrite content continued to correspond to the starting mixture.

It was thus able to be shown that sodium hydroxide as possible decomposition product in the nitrite salt composition according to the invention was removed by addition of NO together with air without the composition being significantly changed. This increases the long-term stability of the melts.

### Example 3

500 g of a salt mixture composed of 7% by weight of sodium nitrate, 53% by weight of potassium nitrate and 40% by weight of sodium nitrite were placed together with 5 g of sodium carbonate in a stirred stainless steel apparatus at 300° C. 15.2 g of nitrogen monoxide (NO) mixed with 10 l of air were subsequently introduced into the melt over a period of two hours. The originally insoluble sodium carbonate had been completely dissolved after the experiment. After the end of the experiment, a homogeneous sample of the melt was dissolved in water and analyzed. The analysis showed that the total carbon content had dropped from the original theoretical 0.11% by mass to 0.02% by mass, while the nitrite content continued to correspond to the starting mixture.

It was thus able to be shown that nitrogen monoxide together with air partially removes sodium carbonate as possible decomposition product from the nitrite salt composition according to the invention, which increases the long-term stability of the salt mixtures.

### Example 4

A salt bath sample was taken from a salt bath reactor which had been operated for 14 years at up to 520° C. using 55% by weight of potassium nitrate and 45% by weight of sodium nitrite as salt bath, dissolved in water and analyzed. The analysis indicated a hydroxide content of 0.6 g/100 g.

26.4 g of nitrogen dioxide and 8 g of nitrogen were introduced into 400 g of this salt mixture below the surface of the melt at 300° C. under a nitrogen atmosphere in a stirred stainless steel apparatus over a period of 90 minutes. After this experiment, a sample of this salt was dissolved in water and analyzed, giving a hydroxide content below the detection limit (<0.1 g/100 g).

It was thus able to be shown that the decomposition products of a nitrite salt composition which had been thermally damaged during operation could be eliminated by introduction of nitrogen dioxide, which increases the long-term stability of the salt mixtures.

1.-14. (canceled)

15. A method of maintaining or widening the long-term operating temperature range of a heat transfer medium and/or heat storage medium comprising a nitrite salt composition comprising, as significant constituents, an alkali metal nitrate or an alkaline earth metal nitrate or a mixture of alkali metal nitrate and alkaline earth metal nitrate and in each case an alkali metal nitrite and/or alkaline earth metal nitrite, the method comprising bringing all or part of the nitrite salt composition into contact with an additive comprising nitrogen and/or noble gases, in each case with elemental oxygen, the latter in an amount in the range from 0 to 20% by volume, based on the total amount of the additive, in combination with nitrogen oxides and/or compounds which generate nitrogen oxide.

16. The method according to claim 15, wherein the heat transfer medium and/or heat storage medium is used in a power station for generating heat and/or electric energy, in a chemical process technology or in a metal hardening plant.

17. The method according to claim 15, wherein the power station for generating heat and/or electric energy is a solar thermal power station.

18. The method according to claim 17, wherein the solar thermal power station is of the parabolic trough power station, Fresnel power station or tower power station type.

19. The method according to claim 15, wherein the contacting of the heat transfer medium with the additive occurs in a reservoir and/or in the main stream and/or in a reaction space which comprises a partial amount of the heat transfer medium and is arranged in parallel to the main stream of the heat transfer medium.

20. The method according to claim 15, wherein the amount of additive is selected so that a correct nitrite operating concentration is achieved.

21. The method according to claim 15, wherein an amount of the additive which leads to complete neutralization of the nitrite salt composition or setting of a residual basicity in the nitrite salt composition is selected.

22. A process system in which pipes and vessels and/or apparatuses are connected and in which a heat transfer medium and/or heat storage medium comprising the nitrite salt composition defined in claim 15 is present, wherein all or part of the nitrite salt composition is brought into contact with an additive comprising nitrogen and/or noble gases, in each case with elemental oxygen, the latter in an amount in the range from 0 to 20% by volume, based on the total amount of the additive, in combination with nitrogen oxides and/or compounds which generate nitrogen oxide.

23. The process system according to claim 22 wherein the system is a constituent of a power station for generating heat and/or electric energy, a plant of chemical process technology or a metal hardening plant.

24. The process system according to claim 23, wherein the plant for generating heat and/or electric energy is a solar thermal power station.

25. (canceled)

26. A method of generating electric energy in a solar thermal power station using a nitrite salt composition as defined in claim 15 as heat transfer medium and/or heat storage medium, wherein all or part of the nitrite salt composition is brought into contact with an additive comprising nitrogen and/or noble gases, in each case with elemental oxygen, the latter in an amount in the range from 0 to 20% by volume, based on the total amount of the additive, in combination with nitrogen oxides and/or compounds which generate nitrogen oxide.

27. A method of producing nitrite salt compositions as defined in claim 15, wherein mixtures of alkali metal nitrates and/or alkaline earth metal nitrates are brought into contact with an additive comprising nitrogen and/or noble gases, in each case with elemental oxygen, the latter in an amount in the range from 0 to 20% by volume, based on the total amount of the additive, in combination with nitrogen oxides and/or compounds which generate nitrogen oxide, in the temperature range from 150 to 600° C.

28. A method for reducing or eliminating the corrosiveness of a nitrite salt composition, comprising utilizing an additive comprising nitrogen and/or noble gases, in each case with elemental oxygen, the latter in an amount in the range from 0 to 20% by volume, based on the total amount of the additive, in combination with nitrogen oxides and/or compounds which generate nitrogen oxide.
